(19) United States
(12) Patent Application Publication
(10) Pub. No.: US 2023/0058499 A1
(43) Pub. Date: Feb. 23, 2023

(54) Zerspanungswerkzeug und Verfahren zur spanabhebenden Bearbeitung sowie Bearbeitungskopf fuer ein Zerspanungswerkzeug

(71) Applicant: Muri Invest & Management UG, Waldmohr (DE)

(72) Inventor: Murat Yildirim, Waldmohr (DE)

(21) Appl. No.: 17/767,197

(22) PCT Filed: Sep. 21, 2020
(86) PCT No.: PCT/EP2020/076271

§ 371 Date: Oct. 13, 2022

(30) Foreign Application Priority Data
Oct. 7, 2019 (DE) 10 2019 126 824.9

(51) Int. Cl. B23B 27/10; B23B 29/24; B23B 5/26

(52) U.S. Cl. CPC B23B 27/10; B23B 29/24; B23B 5/26; B23B 2250/12

(57) ABSTRACT

The invention relates to a machining tool, to a machining head, and to a method for machining a rotating workpiece (19), with a tool main body (12), with at least one machining head (16, 17) provided on the tool main body (12), said machining head receiving, by way of a holder (21), a cutting edge (31) which is aligned with a working space (18) for the workpiece (19) to be machined, wherein a material feed (41) for a conditioning material (42) to be applied to the surface (20) of the workpiece (19) machined by the cutting edge (31) is arranged downstream of the cutting edge (31) as viewed in the direction of machining.

The invention relates to a machining tool and to a method for machining a rotating workpiece using such a machining tool, as well as to a machining head for such a machining tool.

DE 199 12 979 C1 describes a machining tool for machining a rotating workpiece, such as a brake disc. This machining tool comprises a tool main body on which at least one machining head is provided. The machining head receives, by way of a holder, a cutting edge which points towards a working space in which the rotating tool is provided for machining.

DE 10 2017 126 931 A1 describes a tool arrangement with a cutting body and a method for cooling the cutting body. In this embodiment, it is provided that a minimum-quantity lubrication or a minimum-quantity cooling of the cutting body is made possible by a fluid flow that is supplied through a channel inside the cutting body.

JP H08-118 104 A further discloses a machining tool comprising a diamond-sintered cutting body. Downstream of the cutting edge, separate nozzles are provided between the cutting edge and the machined surface in order to apply a cooling liquid and remove chips.

JP H06-31 502 A further discloses a machining tool which provides for the supply of a cooling liquid through a supply channel in a machining head, wherein at the end of the supply channel and remotely from the cutting edge there is provided a nozzle-shaped insert with a 90° deflection through which the cooling liquid is supplied towards the cutting edge to flush out the chips from the cutting-edge location.

Due to the increasing interest in sustainability and the advancing climate change, there is a focus on saving energy-related expenditure and on reducing emissions. When operating a brake system consisting of brake pad and brake disc, a so-called tribosystem, particulate emissions from the braking operation are produced. In addition, brake discs are subject to wear. Due to the increased environmental and health awareness, a reduction of fine particulate emissions is sought in all areas, in particular also a reduced abrasion by such stationary tribosystems.

In braking systems, parts subject to wear and corrosion have already established themselves with various coating concepts. Materials with greater resistance to abrasion can already be used, such as hard-particle-reinforced aluminium matrix composites (AMCs). These AMC composites require special machining to generate a tribofilm on the surface of the machined composite material, said film reducing wear and thus particle emission. This objective for particle emission applies not only to brake systems, but also to other tribosystems.

The object of the invention is to propose a machining tool as well as a method for machining a rotating workpiece as well as a machining head for such a machining tool so that conditioning of the machined surface of the workpiece is made possible after the machining operation.

This object is achieved by a machining tool for machining a rotating workpiece, in which at least one machining head is provided on a tool main body, said machining head receiving a cutting edge by way of a holder and the cutting edge being oriented towards a working space for the workpiece to be machined, and a material feed for a conditioning material to be applied to the surface of the workpiece machined by the cutting edge being provided downstream of the cutting edge as seen in the machining direction. The feed opening of the material feed is provided adjacently to a flank face of the cutting edge. As a result of this material feed assigned downstream of the cutting edge, the distance between the machining point and the feed of the conditioning material is reduced to a minimum, so that the conditioning material is applied to the machined surface of the material within a short period of time after machining and the surface is closed. This can largely or completely prevent a possible reaction of the machined surface with the surrounding environment. In addition, by applying the conditioning material, a tribofilm for wear reduction can be applied to the surface of the workpiece. At the same time, this can also enable an increase in the service life of such workpieces, especially in the case of tribosystems, such as brake discs and brake linings.

Furthermore, it is preferably provided that the material guide is provided on the machining head or adjacently to the machining head. This makes it possible to adapt the material feed to the workpieces to be machined and/or to the conditioning material to be fed.

Preferably, the material feed is provided on or in the holder of the machining tool. This allows a compact design of the machining head.

In particular, it is provided that a feed opening of the material feed is located in an end face of the holder facing the working space and preferably extending at a relief angle equal to or greater than that of the cutting edge. This allows the conditioning material to be fed close to the machining point of the workpiece.

The material feed is preferably formed as a bore in the holder and has an opening opposite the feed opening for loading the conditioning material. This means that the conditioning material on the one hand can be easily loaded at the holder and that the conditioning material on the other hand can be fed directly adjacently to the machining location or the machining point of the tool.

A dispensing device is preferably provided on the holder of the machining head, opposite the cutting edge, and is used to guide the conditioning material out through the material feed in the direction of the working space. This enables the conditioning material to be fed in a compact design through the material feed provided on or in the holder.

Alternatively, it can be provided that the dispensing device is provided separately from the holder of the machining head and can be positioned relative to the working space. In this embodiment, the dispensing device comprises the material feed with a feed opening, through which the conditioning material can be fed or dispensed onto the surface of the workpiece to be machined. According to the alternative embodiment, the dispensing device can be designed as a separate assembly to the machining head and can be positioned separately from the machining head relative to the workpiece to be machined.

Advantageously, the dispensing device is detachably fastened to the holder. On the one hand, this enables easy insertion of the conditioning material into the holder. On the other hand, different dispensing devices can be provided depending on the conditioning material, for example in order to control the feed rate and/or the feed force accordingly. The dispensing device can also be firmly provided on the holder, in particular firmly soldered on.

The dispensing device preferably has at least one connection opposite the holder for controlling the dispensing device. This enables the media supply provided at a machining apparatus to be connectable to the dispensing device.

Advantageously, the dispensing device comprises a pressurisable plunger through which the conditioning material can be guided out through the feed opening of the material feed. For example, a simple control of the dispensing device is made possible by applying compressed air or hydraulics.

Furthermore, it is preferably provided that the conditioning material is provided in the form of a stick or rod or as a profiled body and can be inserted into the material feed formed as a bore. The conditioning material can also be formed as a friction lining, in particular plate-shaped or rectangular. The plunger of the dispensing device can also have a ram or pin that engages with the conditioning material in order to convey it through the bore of the material feed.

In an advantageous embodiment of the machining tool, it is provided that a feed opening of the material feed for the conditioning material is oriented pointing towards the working space and is preferably oriented at an angle of 90° or at an angle of less than 90° to the working space. On the one hand, the conditioning material can be supported by the holder directly into the working chamber. On the other hand, the preferred design of the feed opening at an acute angle to the working space can allow the cross-sectional area for applying the conditioning material to be increased.

On the tool main body, two machining heads are preferably provided opposite each other, between which a gap-shaped working space is formed. This allows two opposing surfaces of the workpiece to be machined simultaneously.

Advantageously, at least one machining head is provided displaceably on the tool main body to adjust the width of the working space. This allows a simple adjustment of the working space to the oversize of the supplied workpiece to be removed by machining. Advantageously, the adjustment of the at least one machining head in respect of the width of the working space can be provided by a drive. This can be achieved, for example, by a manual adjustment screw to allow fine adjustment. An electric, pneumatic, electromagnetic and hydraulic drive can also be provided.

At least one machining head is adjustable in the height of the cutting edge, in particular is adjustable relative to the opposite cutting edge. This allows both cutting edges to be adjustable to the same tip height.

The cutting edge on the machining head is preferably tilted negatively to the working space, in particular in a range of 1° to 10°. This allows an improved surface quality to be achieved on the workpieces to be machined.

Furthermore, it can preferably be provided that the main cutting edge is oriented with an angle of 1° to 10° to the working space. An advantageous adjustment range can be selected according to the selection of the material of the cutting edge and/or the geometry of the cutting edge and/or the workpiece to be machined.

A cutting insert receptacle is preferably provided on the holder of the machining head in order to arrange cutting inserts, in particular indexable cutting inserts, interchangeably. This enables simple conversion of the machining tool to the particular material to be machined. Alternatively, it can be provided that the holder comprises a brazed cutting edge.

Advantageously, the holder can be equipped with a WIPER cutting edge. This allows simultaneous machining and subsequent smoothing of the machined workpiece surface.

The object forming the basis of the invention is further achieved by a method for machining a rotating workpiece, in which a machining tool with a tool main body is used for clamping in a machining apparatus, said tool comprising at least one machining head provided on the tool main body, the machining head receiving a cutting edge by way of a holder and being oriented towards a working space for the tool to be machined, wherein a conditioning material, viewed in the machining direction of the cutting edge, is subsequently applied, by means of a material feed, to the surface of the workpiece machined by the cutting edge, immediately after the machining operation. In this way, the machining operation and the application of a conditioning material to form a tribofilm or to condition the machined surface can be carried out in immediate succession. This allows a conditioning of the surface of the workpiece machined by the cutting edge. In this way, a surface closed with the conditioning material can be created.

Furthermore, it is preferably provided that the conditioning material is formed as a solid body and is applied by friction by the material feed to the surface to be machined. On the surface of the material, the conditioning material in contact therewith forms a friction surface so that the conditioning material is transferred to the surface of the machined workpiece due to the contact with the surface and the resulting abrasion.

Furthermore, it is preferably provided that the conditioning material is fed to the working space through a material feed provided in the holder of the machining head via a feed opening provided on the end face of the holder. The feed opening is preferably aligned with the flank face of the cutting edge on the holder. This allows the holder to perform a dual function, specifically to hold the cutting edge on the one hand and to feed the conditioning material directly adjacently thereto on the other.

It is preferably provided that a diameter or a cross-sectional area of the conditioning material, which is in contact, as a friction surface, with the surface of the machined workpiece, is equal to or greater than a cutting edge radius of the cutting edge or equal to or greater than the width of a turning track on the surface of the workpiece produced by the cutting edge geometry of the cutting edge. As a result, the turning track produced by the machining operation is closed immediately thereafter by the conditioning material and preferably a film is applied.

According to a preferred embodiment of the method, a dispensing device for the conditioning material is connected to the holder of the machining material and the conditioning material is dispensed via a feed opening on the holder. This embodiment allows the conditioning of the produced turning track by the conditioning material immediately after the machining of the surface of the workpiece. Alternatively, it can be provided that the dispensing device is arranged separately from the machining head and is positioned and oriented relative to the surface of the workpiece to be machined. The conditioning material is dispensed onto the machined surface of the workpiece via a feed opening in the dispensing device.

Advantageously, it is provided that the conditioning material is provided in the form of a rod or stick and is fed by means of a dispensing device through the die guide onto the surface of the workpiece to be machined. This allows parameters for the feed the conditioning material to be adjusted.

The conditioning material is preferably subjected to a pressure by the dispensing device, by means of which pressure the conditioning material is guided out of the material feed and the contact pressure of the friction surface of the conditioning material on the surface of the machined workpiece is influenced. This dispensing device can be used to set a contact pressure of the conditioning material against the machined surface.

Preferably, it is provided that the conditioning material is subjected to a constant pressure by the dispensing device. This makes it possible to set equal friction conditions in the application of the conditioning material.

The dispensing device can be driven hydraulically, pneumatically, electromagnetically or in a motor-driven fashion to dispense the conditioning material, and the dispensing pressure can be controlled by a control device of a machining apparatus for the machining. This enables individual adaptation to the material of the workpiece to be machined.

The object forming the basis of the invention is further achieved by a machining head for a machining apparatus having a holder which receives a cutting edge, wherein said machining head comprises the advantageous embodiments described above relating to the machining head.

The invention and other advantageous embodiments and further developments thereof are described and explained in more detail below with reference to the examples shown in the drawings. The features to be inferred from the description and the drawings can be applied individually or in any combination in accordance with the invention. In the drawings:

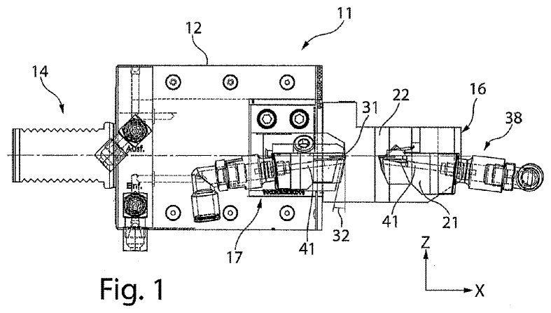

FIG. 1 shows a schematic side view of a machining tool,

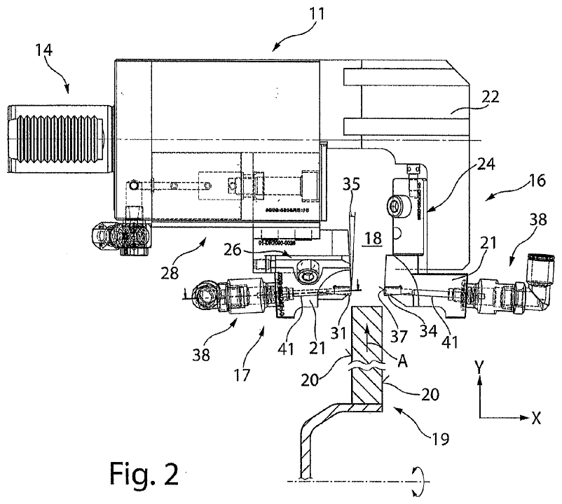

FIG. 2 shows a schematic top view of the machining tool according to FIG. 2,

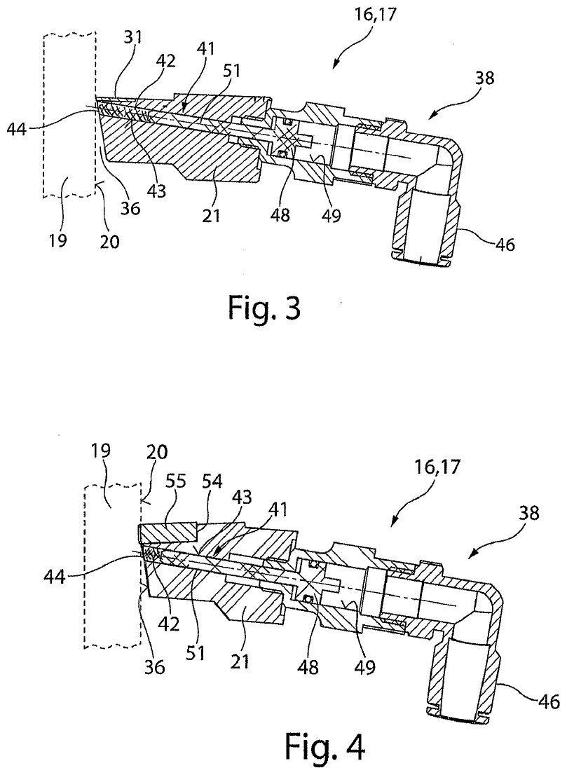

FIG. 3 shows a schematic sectional view of a first embodiment of a machining head of the machining tool according to FIG. 1,

FIG. 4 shows a schematic sectional view of an alternative embodiment of the machining head to FIG. 3, and

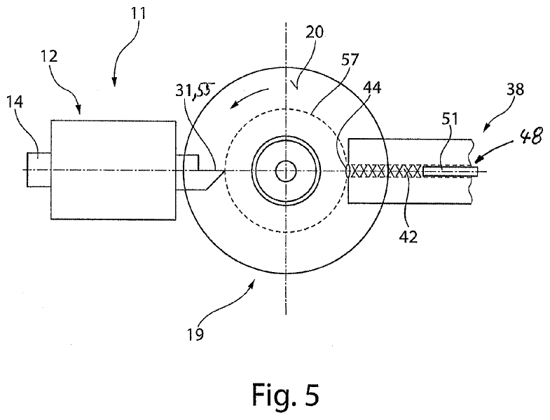

FIG. 5 shows a schematic side view of an alternative embodiment to FIG. 1.

FIG. 1 shows a schematic side view of a machining tool 11. FIG. 2 shows a schematic top view of the machining tool according to FIG. 1. Such a machining tool 11 comprises a tool main body 12, on which an interface 14 is provided. Via this interface 14, the tool main body 12 can be clamped and/or held in a machining apparatus, not shown in more detail, for at least one machining operation. A first and second machining head 16, 17 are provided on the tool main body 12. Two exemplary embodiments of such machining heads 16, 17 are shown in a sectional view in FIGS. 3 and 4. The machining heads 16, 17 are provided opposite each other. A working space 18, in particular in the form of a working gap, is formed between the machining heads 16, 17. A workpiece 19 to be machined, which is driven in rotation by the machining apparatus, is introduced into the working space 18 by an advancing movement. Machining takes place here, for example to remove an oversize from the workpiece 19 to be machined. Two opposing surfaces 20 of the workpiece 19 can be machined simultaneously.

In the embodiment shown in FIGS. 1 and 2, it is provided that the machining head 16 is arranged on an L-shaped support 22. An adjustment device 24 is provided on this support 22. The machining head 16 is adjustable in height relative to the opposite machining head 17 by the adjustment device 24. This adjustment device 24 can be controlled manually, for example by means of the adjustment screw shown, by means of which fine adjustment is possible. Alternatively, the adjustment device 24 can also be controlled by a pneumatic, hydraulic, electric, electromagnetic or mechanical drive. This drive can be controlled by a control device of the machining apparatus.

The machining head 17 is, for example, received on the tool main body 12. An adjustment device 26 is provided between the tool main body 12 and the machining head 17. The width of the working space 18 between the two machining heads 16, 17 can be adjusted by means of this adjustment device 26. This adjustment device 26 can also be controlled manually by means of the adjustment screw or by a drive, analogously to that described for the adjustment device 24, by the control device of the machining apparatus.

Alternatively, it can be provided that each machining head 16, 17 is assigned the adjustment device 24 and/or adjustment device 26.

The tool main body 12 can further comprise an advancing device 28. By means of this advancing device 28, only one machining head 16, 17 or both machining heads 16, 17 can be controlled to be movable with respect to the width of the working space 18. In particular, after completion of the machining of the workpiece 19, a moving apart of at least one machining head 16, 17 can be controlled by the advancing device 28, so that a simple removal of the machined workpiece 19 from the working space 18 is made possible. This advancing device 28 can be controlled pneumatically, hydraulically, electrically, electromagnetically or the like, preferably by the control device of the machining apparatus.

The machining head 16, 17 comprises at least one holder 21. A cutting edge 31 is provided on each holder 21 of the machining head 16, 17. The positioning and orientation of the particular cutting edge 31 relative to the working space 18 can be adjusted by the machining head 16, 17 and/or the holder 21.

The holder 21 has an end face 36 which faces the working space 18 and which is located behind the cutting edge 31 as seen in the machining direction. This end face 36 is arranged at an angle which is equal to or greater than the flank face of the cutting edge 31.

The machining head 16, 17 preferably comprises in each case a dispensing device 38, which is detachably fastened to the holder 21. For example, a screw connection, clamp connection or bayonet connection can be provided. A material feed 41 for a conditioning material 42 is provided in the holder 21. The detachable arrangement of the dispensing device 38 to the holder 21 allows the conditioning material 42 to be inserted into the material feed 41. Preferably, the material feed 41 is formed as a bore 43. This bore passes through the holder 21. A feed opening 44 of the material feed 41 is provided in the end face 36 of the holder 21. Preferably, this feed opening 44 is directly adjacent to the cutting edge 31. This can be seen, for example, in the schematic sectional view of the machining head 16, 17 according to FIG. 3.

The dispensing device 38 comprises a connection 46. This connection can be connected to by a media connection of the machining apparatus. Preferably, a compressed air connection is provided at the connection 46. In the dispensing device 38, a pressurisable plunger 48 is displaceable in a plunger guide 49. This plunger 48 comprises a pin-shaped end 51 which engages in the material feed 41 and guides the conditioning material 42 through the material feed 41.

The conditioning material 42 is preferably formed as a solid body. For example, it can be provided in the form of a stick. The cross-section of the conditioning material 42 is adapted to the material feed 41. The cross-section of the material feed 41 can be round, polygonal or profiled. The cross-section of the conditioning workpiece 42 is preferably adapted thereto.

The feed direction of the conditioning material 42 is preferably at an angle of less than 90° to the working space 18 or to the surface 20 of the workpiece 19 to be machined.

The feed opening 44 of the material feed 41 is preferably located directly behind the nose of the cutting edge 31, as seen in the machining direction. A turning track is created during the machining of the surface 20 of the workpiece. The feed of the conditioning material 42 through the material feed 41 is provided in such a way that the conditioning material 42 is assigned directly to the turning track. The application of the conditioning material 42 to the surface 20 of the machined workpiece 19, in particular to the turning track, creates a friction surface on the conditioning material 42, by means of which the turning track is conditioned with the conditioning material 42. Due to the contacting friction surface of the conditioning material 42, a film or coating is formed on the turning track from the conditioning material. This can create a conditioning film or a tribofilm.

FIG. 3 shows an enlarged view of the machining head 16, 17 according to FIGS. 1 and 2. The holder 21 of the machining head 16, 17 receives a brazed cutting edge 31. These cutting edges 31 can be made of an ultra-hard cutting material, such as carbide or cutting materials such as CVD-D (CVD thick-film diamond), PCD (polycrystalline diamond) or CBN (cubic boron nitride).

Preferably, a tip height of the mutually opposed cutting edges 31 is almost zero or is zero. Furthermore, the cutting edges 31 have a relief angle 32 (FIG. 1), which is preferably between 1° and 15°, in particular between 4° and 10°.

Furthermore, the secondary cutting edge 37 is preferably oriented at an angle of up to 7°, preferably 2 to 4°, to the surface 20 of the workpiece 19 to be machined. The cutting edges 31 are preferably oriented at an angle of inclination of 0° to the surface 20 of the workpiece 19 to be machined. In the case of the cutting edge 31, the main cutting edge 34 can be at a rake angle, for example between 1° and 10°, preferably 4° to 6°. The secondary cutting edge 37 can be oriented at an angle 35 as shown in FIG. 2 of, for example, 1° to 10°, preferably 2° to 5°. The design of the cutting edge 31 and its positioning at the machining angles to the surface 20 of the workpiece 19 of the workpiece 19 to be machined depends, among other things, on the material of the workpiece to be machined, the machining speed, the requirement for the quality of the surface 20 of the workpiece 19 or the like.

FIG. 4 shows an alternative embodiment of the machining head 16, 17 to FIG. 3. This machining head 16, 17 differs in the design of the holder 21. This has a cutting insert receptacle 54 for interchangeably receiving a cutting insert 55. These cutting inserts 55 can preferably also be formed as indexable cutting inserts, which can also have cutting edges consisting of the cutting materials PCD, CBN and the CVD thick-film diamond or carbide.

The cutting inserts 55 provided on the machining head 16, 17 are preferably directed in the same way as for the embodiment of brazed cutting edges on the holder 21. Preferably, also in this exemplary embodiment, a tip height of the opposing cutting edges 31 is equal to zero. Furthermore, the rake face of the main cutting edge 34 can be negatively inclined to the holder 21 by 5° to 15°, preferably 8° to 11°. Furthermore, the cutting edges 31 of the cutting inserts 55 may have a relief angle 32 (FIG. 1), which is preferably in a range between 1° to 15°, in particular between 4° to 8°. The main cutting edge 34 can be oriented at a rake angle between 1° to 8°, preferably 4° to 6°, to the surface 20 of the workpiece 19 to be machined. The secondary cutting edge can be oriented according to the angle 35 (FIG. 2) in a range of 1° to 15°, preferably 3° to 6°, to the surface 20 of the workpiece 19 to be machined.

A cutting edge with a WIPER geometry can also be used on such a holder 21 with a cutting insert receptacle 54. Such a cutting insert allows an improved surface finish, since the WIPER geometry smooths one or more previously produced turning tracks.

The workpiece 19 to be machined can be, for example, a light metal brake disc. Both surfaces 20 of a friction ring of the brake disc are machined simultaneously. This brake disc can be made of aluminium matrix composites (AMC) strongly reinforced with hard-material particles. These machining heads 16, 17 are adjusted to a working space 18. The width of the working space 18 corresponds to the manufacturing dimension for the machining of the friction ring of the brake disc. Subsequently, the brake disc or the workpiece 19 is driven in rotation and fed to the working chamber 18 according to arrow A. The friction ring of the brake disc is machined simultaneously and on both sides. At the same time, the dispensing device 38 is driven, in particular pressurised, so that the conditioning material 42 lies against the particular surface 20 of the friction ring or the workpiece 19. Due to the advancing movement of the machining apparatus, the workpiece 19 moves increasingly into the working space 18 until the surface 20 to be machined is completed.

This machining tool 11 is used to apply the conditioning material 42 directly at the machining location. A change of the surface 20 due to oxidation or the like can thus be virtually prevented. In addition, the direct application of the conditioning material 42 allows a closed conditioning of the machined surface 20 of the workpiece 19.

FIG. 5 shows a schematic side view of an alternative embodiment of the machining tool 11 to FIG. 1. In this embodiment of the machining tool 11, the conditioning material 42 is not fed via the holder 21, which accommodates the cutting edges 31, 55.

In this embodiment, the machining head 16, 17 comprises the holder 21, which receives the brazed cutting insert 31 or the indexable cutting inserts 55. This holder 21 can be provided on the relevant adjustment device 24, 26 and/or the advancing device 28 in order to adjust the machining width or gap width of the working space 18 between the mutually opposed cutting edges 31, 55 as well as their positioning relative to the surface 20 of the workpiece 19 to be machined.

The dispensing device 38 for dispensing the conditioning material 42 onto the machined surface 20 of the workpiece 19 is arranged separately from the holder 21. The dispensing device 38 is positioned downstream of the holder 21 towards the workspace 18. This downstream arrangement can be immediately adjacent to the holder 21 or can be positioned, for example, pivoted through 90°—or as shown—pivoted through 180° downstream of the holder 21.

The dispensing device 38 comprises the material feed 41, through which the conditioning material 42 is dispensed via the feed opening 44 and is spread or applied on the machined surface 20 of the workpiece 19. For dispensing the conditioning material 42, the dispensing device 38 is connected to, for example, a compressed air supply via a connection not shown in greater detail. Such a connection 46 of the dispensing device 38 is shown in FIGS. 3 and 4. The dispensing device 38 according to FIG. 5 also comprises a plunger 48, of which only the pin-shaped end 51 for dispensing the conditioning material 42 is shown. This dispensing device 38 can be formed analogously to one of the embodiments described above.

The dispensing device 38 is controlled in synchronisation with the advancing movement of the holder(s) 21. The surface 20 of the workpiece 19 is machined by the cutting edge 31, 55 and a so-called track 57 is formed. The feed opening 44 of the material feed 41 of the dispensing device 38 is positioned in such a way that it lies in the track 57 of the cutting edge 31, 55 of the machining tool 11. The advancing movement of the cutting edges 31, 55 of the machining tool 11 corresponds to the advancing movement of the dispensing device 38, so that the conditioning material 42 follows the track 57, which is newly formed by the cutting edges 31, 55 on the surface 20 to be machined of the workpiece 19.

Alternatively, it can be provided that two or more dispensing devices 38 are assigned adjacently to each other to the same track 57. It can also be provided that one dispensing device 38 is aligned with the track 57 formed by the cutting edge 31, 55 and, for example, a further dispensing device 38 is offset by one or more tracks relative to the currently formed track 57 to allow additional finishing by the application of conditioning materials 42. The dispensing device 38 and the machining tool 11 are preferably arranged on the same machining apparatus and are controlled by the controller of this machining apparatus with respect to the feed or the movement relative to the surface 20 of the workpiece 19 to be machined.

1. A machining tool for machining a rotating workpiece, with a tool main body, with at least one machining head which is provided on the tool main body and which, by way of a holder, receives a cutting edge which is oriented towards a working space for the workpiece to be machined, wherein a material feed for a conditioning material to be applied to the surface of the workpiece machined by the cutting edge is provided downstream of the cutting edge as viewed in the machining direction, wherein the feed opening of the material feed is provided adjacently to a flank face of the cutting edge.

2. The machining tool according to claim 1, wherein the material feed is provided on the machining head or is assigned to the machining head or wherein the material feed is provided on or in the holder of the machining head.

3. (canceled)

4. The machining tool according to claim 1, characterised in that wherein the material feed has a feed opening which is oriented pointing towards the working space and is oriented at an acute angle to the working space.

5. The machining tool according to claim 4, wherein the feed opening of the material feed lies in an end face of the holder facing the working space, and the end face of the holder is provided at a relief angle which is equal to or greater than that of the cutting edge, and wherein the material feed is formed as a bore in the holder, said bore having an opening opposite the feed opening for loading the conditioning material.

6. (canceled)

7. The machining tool according to claim 1, wherein a dispensing device is provided, by means of which the conditioning material is guidable out through the material feed in the direction of the working space, said dispensing device being provided on the holder of the machining head or being positionable separately from the machining head in the working space.

8. The machining tool according to claim 7, wherein the dispensing device is detachably fastened to the holder or wherein the dispensing device has at least one connection opposite the holder for controlling the dispensing device or wherein the dispensing device has at least one plunger to which pressure is applyable and by means of which the conditioning material is guidable out of the feed opening of the material feed.

9. (canceled)

10. (canceled)

11. The machining tool according to claim 2, wherein the feed opening of the material feed for the conditioning material is oriented pointing towards the working chamber at an angle of less than 90° or at an angle of 90° and wherein two mutually opposed machining heads are provided on the tool main body and form a gap-shaped working space.

12. The machining tool according to claim 2, wherein two mutually opposed machining heads are provided on the tool main body and form a gap-shaped working space and at least one of the two machining heads is provided displaceably on the tool main body in order to adjust the width of the working space and/or wherein at least one of the two machining heads is adjustable in the height of the cutting edge of one machining head relative to the opposite cutting edge.

13. (canceled)

14. (canceled)

15. The machining tool according to claim 1, wherein the cutting edges on the machining head are negatively tilted with respect to the working space.

16. The machining tool according to claim 1, wherein the main cutting edge of the cutting edge is oriented at an angle to the working space of 1° to 10°.

17. The machining tool according to claim 1, wherein a cutting insert receptacle for the interchangeable arrangement of cutting inserts is provided on the holder of the machining head, or in that the holder of the machining head comprises a brazed cutting edge.

18. A method for machining a rotating workpiece, in which a machining tool with a tool main body is used, on which at least one machining head is provided, which receives a cutting edge by way of a holder and is aligned with a working space for the workpiece to be machined, wherein a conditioning material, viewed in the machining direction of the cutting edge, is subsequently applied by a material feed to the surface of the workpiece machined by the cutting edge, wherein the conditioning material is applied to the machined surface of the workpiece behind the cutting edge immediately after the machining operation.

19. The method according to claim 18, wherein the conditioning material is formed as a solid body and is applied to the machined surface of the workpiece by friction through the material feed.

20. The method according to claim 18, wherein the material feed is provided in the holder of the machining head and a feed opening of the material feed is aligned with an end face of the holder or is oriented adjacently to the flank face of the cutting edge.

21. The method according to claim 18, wherein a dispensing device is connected to the holder of the machining head and the conditioning material is dispensed via a feed opening on the holder, or in that the dispensing device is positioned separately from the machining head relative to the surface of the workpiece to be machined and the conditioning material is dispensed through a feed opening on the dispensing device.

22. The method according to claim 18, wherein the conditioning material is acted upon by a dispensing device and is guided out of the material feed towards the machined surface of the workpiece.

23. The method according to claim 18, wherein a diameter or a cross-section of the conditioning material which is in contact, as a friction surface, with the surface of the workpiece is selected to be equal to or greater than a width of a turning track produced by the cutting edge geometry of the cutting edge.

24. The method according to claim 18, wherein the conditioning material is formed as a rod-shaped or stick-shaped solid body, or is formed as a profiled body and is fed through the material feed with the dispensing device onto the machined surface of the workpiece.

25. The method according to claim 21, wherein the dispensing device is driven hydraulically, pneumatically, electromagnetically or in a motor-driven fashion to dispense the conditioning material and a pressure to apply to the conditioning material is controlled by a control device of a machining apparatus.

26. (canceled)
